(19) United States
(12) Patent Application Publication
(10) Pub. No.: US 2022/0151193 A1
(43) Pub. Date: May 19, 2022

(54) AUTOMATIC SYSTEM FOR COLLECTION AND DISPOSAL OF ANIMAL DROPPINGS

(71) Applicant: Margareta DUMITRESCU, Catania (IT)

(72) Inventor: Margareta DUMITRESCU, Catania (IT)

(21) Appl. No.: 17/598,320

(22) PCT Filed: Mar. 25, 2020
(86) PCT No.: PCT/IB2020/052793

§ 371 Date: Sep. 27, 2021

(30) Foreign Application Priority Data
Mar. 25, 2019 (IT) 102019000004231

(51) Int. Cl. A01K 1/01

(52) U.S. Cl. CPC A01K 1/011

(57) ABSTRACT

Automatic system for collection and disposal of animal droppings, including: at least one collection plate, configured to receive animal droppings released by one animal (P) supported by said at least one collection plate, at least one discharge through opening being formed in said collection plate; at least one reservoir for a washing fluid, in fluid communication with said at least one collection plate; one assembly for opening-closing said reservoir; one sensor group, configured to sense the presence or absence of at least one animal at said collection plate; one data control and processing unit operatively connected to said sensor group and to the assembly for opening-closing said reservoir. When the data control and processing unit senses, by means of the sensor group, that one animal previously supported by at least one collection plate is moving away therefrom, it sends a suitable control signal to the opening-closing assembly, in response to which the reservoir is opened which can dispense the washing fluid in the collection plate so that the dropping are dragged by the washing fluid in the discharge through opening.

### TECHNICAL FIELD

The present invention relates to an automatic system for collection and disposal of animal droppings, in particular of domestic animals droppings such as dogs, cats, rabbits, ferrets, etc.

### BACKGROUND OF THE INVENTION

Nowadays, trays with litter or sand and scoops are used for the removal of domestic animals droppings. This method requires for a daily, manual cleaning operation. Furthermore, that method leaves unsolved the problem of exhalation of bad odours and of bacteria, which is a particularly problematic drawback when the trays are located in unsuitable, small or closed environments.

Covered trays having carbon filters are also used, to limit the escape of bad odours, but a manual cleaning intervention is always necessary. In addition to the fact that the problem of bad odours cannot be completely eliminated, the higher cost is added. The trays are not used for domestic animals of medium or large size.

Inside dwellings, for medium or large-sized domestic animals, absorbent mats, newspapers or rags are used, which then are thrown away. But, usually, these animals are taken outside, to fulfil their physiological needs outdoors. This causes the real emergency not to be so much the disposal of droppings inside dwellings, where the owners of animals, for love, are willing to endure every type of discomfort. In fact, the real impelling emergency is public space: sidewalks, squares, parks are literally smeared with animal droppings. Almost daily the chronicles of newspapers show this environmental emergency, as well as the discontent of citizens, traders, educational institutions (creches, schools) etc., as can be seen from the article “Escrementi di cani per strada, task force contro chi sgarra: appostamenti e controlli a gogo”, Palermotoday, editing of Feb. 22, 2018.

To give an idea of the scale of the emergency, we must specify that in reality it is tonnes of animal droppings which every year are poured on public ground, with consequent infestation of the soil by parasites, pollution of groundwater, looming threat of infectious diseases for humans and for the animals themselves. Read Susan Freinkel, “The Poop Problem: What to do with 10 million Tons of Dog Waste”, <On Earth Magazine>, Apr. 10, 2014 (www.livescience.com).

For the collection of the animal droppings outside the household environment one proceeds through the scoop or through manual harvest with special bags that are subsequently thrown in holders. The need to force every owner to collect his animal droppings (Clean up after your dog) arises in a stringent manner in the United States since 1970. This obligation becomes law in 1978 in New York City. Further the law has also been adopted in the other Countries and is still in force.

Yet, it is noted that still today, the financial penalties provided for by law for who does not collect the droppings of his domestic animal are not a strong enough deterrent to determine all owners to fulfil their civic duty. All the more so that not all the defaulters are punished, given the difficulty of catch them in flagrant. Precisely for this reason, in order to trace who leaves the droppings of the animal in public place, more sophisticated methods are carried out: the droppings analysis to ascertain the DNA of the animal and thus determine the owner, for fining him. The method has also been adopted in Italy, in some areas. Read in this regard Landoni Lucia, “Escrementi dei cani, i padroni incastrati dalla banca dati del dna: le prime multe nel Varesotto”, <La Repubblica>, Milan, 8 Aug. 2018.

But if in most countries coercive measures are taken against lawbreakers owners, in some countries the virtuous owners are encouraged with rewards: the offer of a number of free minutes for mobile phones, or a lottery ticket, as happened in Taiwan (“Taiwan dog poo lottery proves a <big success>”, 8 Dec. 2011—BBC News).

Through a quick review of “innovative ideas” implemented in various parts of the world in order to dispose of animal droppings it appears that everywhere manual removal is carried out. The same occurs even in Japan, the super-technological country, which for the specific problem proposes nothing else than strategies for inducing the owners to collect the excrement of their animals. David Dodwell, “Some ideas for cleaning up Hong Kong's dog excrement. New York, Paris, Taipe have to come up with innovative ideas to tackle the scourge, but it's probably Spain where creativity really ran free”, Apr. 9, 2017—SCMP.COM “City's poo patrol making slow progress against negligent dog owners”, May 7, 2013. Japantoday.com.

In conclusion, it can be seen that, for half a century since animal droppings have become a major environmental problem in the cities around the world, the only proposed solution is to manually remove the droppings of domestic animals.

### SUMMARY OF THE INVENTION

There is therefore the need to solve the above drawbacks and the main object of the present invention is to provide for a practical and effective system of collecting and disposing of animal droppings, which avoids the exhalation of bad odours, maintains a clean environment and is not uncomfortable to be put into practice for domestic animal owners.

These and other objects of the present invention are achieved by a system for collection and disposal of animal droppings according to claim 1. In the Figures the same reference numerals will be used for similar elements.

### BRIEF DESCRIPTION OF THE DRAWINGS

The present invention will be now described, for illustrative but not limiting purposes, according to its embodiments, with particular reference to the Figures of the accompanying drawings, wherein:

FIG. 1 shows a plan view of a first embodiment of a collection plate of the collection and disposal system according to the invention;

FIG. 2 shows a plan view of a second embodiment of the collection plate of the collection and disposal system according to the invention;

FIG. 3 shows a plan view of a third embodiment of the collection plate of the collection and disposal system according to the invention; and

FIG. 4 shows schematic representation, seen laterally, of a system according to the present invention.

In the enclosed Figures the same reference numerals will be used for similar elements.

### DETAILED DESCRIPTION

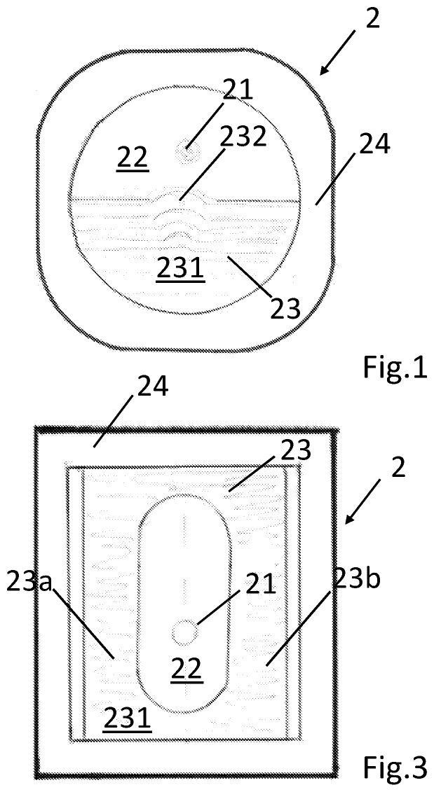

With particular reference to FIGS. 1 to 4, it will be noted that a system for the collection and disposal of animal droppings according to the present invention is generally designated by the reference numeral 1 and includes a collection plate 2, optionally made of porcelain, earthenware, porcelain steel or other suitable material, configured to receive animal droppings produced by an animal which is supported by the collection plate. In the collection plate 2 at least one discharge through aperture 21 is formed, which will be described in greater detail below. Furthermore, the system according to the present invention includes one reservoir 3 for a washing fluid 4, which reservoir is in fluid connection with the collection plate 2, and one assembly 5 for opening-closing the reservoir 3, for example one ball or diaphragm valve suitable for the purpose, between the reservoir 3 and the collection plate 2, whereby depending on the configuration of the assembly 5 for opening-closing the reservoir 3, the washing fluid 4, usually an antiseptic and antibacterial detergent mixed with water, can flow or cannot flow form the reservoir 3 into collection plate 2.

The reservoir 3 may be a stand-alone container or can be connected directly to the water mains. The discharge through opening 21 of the collection plate 2 is configured to be placed in fluid communication with a reservoir for collecting wastewater, not shown in the drawings, or with the sewerage (also not shown).

As will be noted in FIG. 4, the reservoir 3 and the collection plate 2 are in fluid communication through a suitable delivery conduit 6, but the person skilled in the art would certainly have no difficulty in understanding that, depending on the case, the reservoir 3 could also be connected differently to the collection plate 2, for example directly.

Returning to the collection plate 2 of the system 1 according to the invention, it includes one bottom 22 wherein the discharge through opening 21 is formed, and one support base 23, which is raised with respect to the bottom 22 and configured for supporting one animal P.

More particularly, as is evident from FIG. 4, the bottom 22 is delimited by a wall inclined towards the discharge through opening 21, so that the droppings produced by the animal P, when it is supported by the support base 23, can fall directly on the bottom 22 and be naturally conveyed towards the discharge through opening 21. The support base 23, instead, is planar and configured to be placed parallel to the floor or the ground of the environment wherein the system 1 of the present invention can be installed.

As will be noted, the particular configuration of the support base 23 and the fact that it is raised with respect to the bottom 22, as well as the fact that it is configured to be placed parallel to the floor or the ground of the environment wherein the system 1 of the present invention can be installed, allows for the animal, as will be also apparent below, to place itself with no difficulty thereon, it prevents the feet of the animal from getting dirty because of the produced droppings, falling instead on the bottom 22 of the collection plate 2, and moreover it prevents the animal P from dirtying the surrounding environment wherein the system 1 of the present invention is installed.

Depending on the size of the animal P or space requirements, the bottom 22 of the collection plate 2 has a plan circular or polygonal, optionally square or rectangular configuration, and the support base 23 is substantially central or peripheral with respect to the bottom 22.

The support base 23 includes at least one anti-slip portion 231, for example provided with ribs or grooves, the anti-slip portion being machined so as to be corrugated or such that an optionally adhesive an anti-slip material is applied thereto, configured to deliver a certain grip and to avoid that the animal P, during the use of the system, can lose balance and slip, with the risk of getting hurt. With particular reference to FIG. 1, it shows a first embodiment of the collection plate 2 of the system according to the invention, suitable in particular for small animals, optionally having a weight less than or equal to about 10 kg. Such plate shows a bottom 22 of substantially circular configuration, for example having a diameter included between 20 and 40 cm, optionally included between 25 and 35 cm, even more optionally equal to about 30 cm. The support base 23, according to the first embodiment of the invention, extends above the bottom 22, covering a substantially semicircular portion above the bottom, which portion delimits the anti-slip portion 231 referred to above, in which grooves are formed to make the surface less smooth. The collection plate 2 also includes a peripheral frame 24, having a substantially square plan configuration with rounded corners, the bulk thereof (in plan view), for example between 28×28 cm and 48×48 cm, optionally between 33×33 cm and 43×43 cm, optionally approximately 38 cm×38 cm, based on the size of the bottom 22. The particular configuration of the support base 23 is due to the fact that small animals do not have to spread their feet apart very much during defecation. As regards the plan extension of the support base 23, with respect to the underneath bottom, it may extend for a length optionally included between 15 and 21 cm, optionally equal to about 18 cm from the bottom 22 perimeter and toward the center of the collection plate 2. Not only that, in the support base 23 a recess 232 can also be formed, optionally ranging between 5 and 7 cm, optionally equal to about 3 cm, at a central area of the support base 23 edge facing the bottom 22. Finally, as can be seen, the discharge opening 21, formed in the bottom of the collection plate 2, can be in an eccentric position with respect to the bottom itself.

It is self-evident that the collection plate 2 described above can be used by a small size animal which is positioned rearward with respect to the collection plate 2, i.e. with the tail oriented toward the discharge through opening 21 and four feet resting on the support base 23. In this regard, it will be noted that the recess 232 facilitates the urine flow, released by male animals, toward the bottom 22 of the collection plate 2.

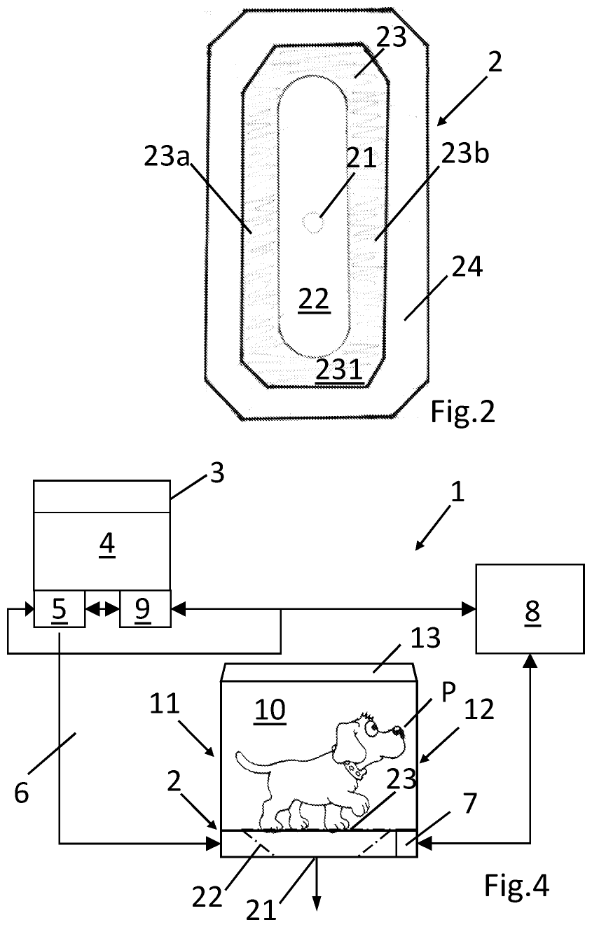

With particular reference to FIG. 2, the Figure shows one collection plate 2 of the system 1 according to the invention, for large and very large size animals, optionally having weight equal to or greater than 25 Kg. In this case the collection plate 2 includes one bottom 22 of substantially rectangular configuration above which there is a peripheral support base 23, which delimits at least two lateral portions 23a and 23b, optionally anti-slip portions 231, configured to support the feet of one animal P. The lateral portions 23a and 23b of the support base 23 are configured to facilitate the use of the system 1 by a large or very large size animal, which has more difficulties compared to a small size animal in coordinating deambulation and maintaining balance, allowing it to advance on the lateral portions 23a and 23b of the support base and, after defecation, proceed in the same direction for leaving the collection plate 2. Purely by way of illustration and not of limitation, the bottom 22 of the collection plate 2 may have dimensions included between 40×60 cm and 60×80 cm, optionally approximately 50×70 cm. The peripheral support base could delimit at least two lateral portions 23a and 23b or dimension included between 8 and 16 cm, optionally equal to about 12 cm. Also in this case frame 24 can be provided.

The particular configuration of the collection plate can be used for large or very large size animals, which can move forward on the two lateral portions 23a and 23b, and proceed in the same direction for leaving the collection plate 2, because, due to their size they could not move easily rearward on the two lateral portions. This particular configuration of the collection plate 2 is also particularly practical for the use of the system in public places.

Moreover, as for the embodiment of FIG. 1, it is clear that the fact that the support base 23, with its two lateral portions 23a and 23b, is raised with respect to the bottom 22, includes an anti-slip portion 231 and is configured to be placed parallel to the floor or the ground of the place wherein the system 1 of the present invention can be installed, allows for the animal P to place itself with no difficulty thereon, it prevents the feet of the animal from getting dirty by the produced droppings, which instead fall on the bottom 22 of the collection plate 2, and also prevents the animal P from dirtying the surrounding environment wherein the system 1 of the present invention is installed. Similarly to what has been described above with reference to FIG. 2, in FIG. 3 a collection plate 2 for animals of medium size, of weight substantially included between 10 and 25 kg, is shown. Such collection plate 2 is substantially symmetrical, as the collection plate 1 of FIG. 1, and is expected to be used by an animal P without a preferential direction of use. Always by way of illustration and not of limitation, it is noted that the bottom 22 could have dimension included between 30×30 cm and 50×50 cm, optionally approximately 40×40 cm. Optionally, the plate could have one plan dimension (width or length) slightly larger than the other (length or width).

The collection plate shown in FIG. 3 represents an intermediate solution between the collection plate of FIG. 1 and that of FIG. 2, in the sense that it can be used in cases where the space available is not high. The animal that uses it can use it, in fact, in a twofold way. It can use it by positioning itself rearward with respect to the collection plate (as is foreseen for the collection plate 2 shown in FIG. 1) and in this case the discharge through opening 21 has been provided eccentric with respect to the bottom 22 to facilitate discharge of droppings by animals positioning themselves rearward with respect to the collection plate. Alternatively, if the space available is enough, the animal P can use the collection plate 2 by moving forward, as indicated with reference to FIG. 2, in a single direction which also corresponds to the direction for leaving the collection plate 2, at the end of defecation. This configuration of the collection plate 2, with double possibility of positioning on the two lateral portions can be made for use of the system in private homes. Also in this case it is clear that the fact that the support base 23, with its two lateral portions 23a and 23b (see FIG. 3), is raised with respect to the bottom 22, includes an anti-slip portion 231 and is configured to be placed parallel to the floor or the ground of the place wherein the system 1 of the present invention can be installed, allows for the animal P to place itself with no difficulty thereon, it prevents the feet of the animal from getting dirty by the produced droppings, which instead fall on the bottom 22 of the collection plate 2, and also prevents the animal P from dirtying the surrounding environment wherein the system 1 of the present invention is installed.

According to one variant of the present invention, particularly usable when the system 1 of the invention is used in the domestic environment, the collection plate 2 of the system 1 can also include one tray (not shown in the Figures), to be placed on the support base 23, so as to completely cover the support base and the bottom 22 underneath. Such tray is configured to be strewn with litter or sand and to be used, for example, during the first few days of use of the system 1 according to the invention, so as to allow the animal P to become accustomed to the place. According to one variant of the invention, the tray can be configured so as to completely cover the support base 23 and the bottom 22 underneath or can have an extension such that it can occlude the space above the bottom 22 of the collection plate 2 but does not cover all or part of the support base 23.

The system 1 according to the present invention further includes at least one sensor group 7, configured for detecting the presence or absence of one animal P at the collection plate 2, and a data control and processing unit 8, which is operatively connected to the sensor group 7 and the assembly 5 for opening-closing the reservoir 3, so that when the data control and processing unit 8 detects, by means of one signal sent by the sensor group 7, that one animal P, previously supported by the collection plate 2 is moving away from the plate itself, it sends a suitable control signal to the opening-closing assembly 5, in response to which the reservoir 3 is opened and can deliver the washing fluid 4 into the collection plate 2 so that the droppings released by the animal P can be dragged by the washing fluid 4 in the discharge through opening 21 and therefore disposed of into the reservoir for collecting wastewater or into the sewer.

The sensor group 7 includes one or more between: one weight sensor, for example one or more load cells, configured to detect the weight of one animal P supported by the support base 23 of the collection plate 2; one position sensor, for example implemented by means of LED photocells or one infra-red presence sensor, configured for detecting the presence or absence of such animal P on the collection plate 2.

The system 1 of the invention also includes one adjustment group 9, operatively connected to the assembly 5 for opening-closing the reservoir 3 and to the data control and processing unit 8, which adjustment group is configured to adjust the flow rate and pressure of the washing fluid 4 delivered by the reservoir 3, based on what is sensed by the sensor group 7 and processed by the control and processing unit 8.

Thus, for example, the pressure and the flow rate of the fluid 4 can be adjusted in such a way that the greater the weight of the animal P detected by the sensor group 7 the higher pressure and the flow rate are. Also the delivery time of the washing fluid 4 can be adjusted, by acting on the opening-closing assembly 5 of the system, and can be included for example between 1 and 10 seconds.

The data control and processing unit 8 can activate the delivery of the washing fluid 4 as soon as the animal P is moved away from the collection plate 2, based on what is detected by sensor group 7 and, in addition, it can foresee to automatically dispense the washing fluid 4 at regular intervals, e.g. with sanitizing function, independently from the fact that the animal P has just left the collection plate 2 or not. The sanitation at regular intervals of the collection plate 2 is clearly advantageous if the system 1 is installed in a public place.

For illustrative purposes, in the following some guidelines for the proper installation of the system 1 of the invention are provided. In particular, in order to avoid infiltrations, between the collection plate 2 and, for example, the floor of a house or a building wherein the system 1 of the invention is installed, it is provided to place at least one sealing element, such as for example a lead plate, not shown in the drawings.

The system 1 of the present invention is configured to be installed on the floor or the ground, so that the support base 23 is placed parallel thereto, at a distance in height from the floor or the ground included between 0 cm and 10 cm (above or below the floor or ground), optionally included between 0 cm and 5 cm, in particular equal to 0 cm. The installation shall be possibly carried out in such a way that the support base 23 of the plate is flush with the floor or the ground of the surrounding environment wherein the system 1 according to the invention is installed, and, as regards the connection to the water mains and sewerage system, it is desirable to connect the system 1 directly to the water mains and sewerage system of the dwelling or building or, if there is a toilet in the same environment wherein the system 1 of the invention is installed, it is desirable to directly connect the system to the ducts connecting to the toilet.

The reservoir 3 can also be placed at a higher level with respect to the plate, so that the washing fluid 4 can reach the collection plate 2 also by gravity, and the reservoir can be fit within a wall of the environment wherein the system is installed 1 or may be fixed externally to the wall.

The data control and processing unit 8 can be clearly connected to an electric network or can be battery powered and, between the electric power supply network and the data control and processing unit 8 a safety transformer of the traditional type can also be provided, placed in a junction box, and the safety transformer can be inspected, for example in the case of failure.

The system 1 of the invention can also include one or more side walls 10, optionally two and, in the particular case wherein they are two, opposite with respect to the collection plate 2 and delimiting at least one entrance 11 and one exit 12 with respect to the collection plate 2. The system 1 according to the invention may also include one roof element 13 of the collection plate 2, which roof element is supported by the side walls 10, when present.

According to one variant of the invention, the side walls 10 delimit one entrance side 11 and one exit side 12 with respect to the collection plate 2, whereby the animal P can enter from side 11 and, after having used the system 1 of the invention, exit from the other side 12.

The material of the side walls 10 and of the roof element 13, which delimits a sort of a box, must be resistant both to bad weather and high temperatures and can include, for example, high density polyester. The roof element 13 can be made of transparent or translucent white material, to allow the passage of the sun rays and/or the system 1 of the invention can include one light source, not shown in the drawings, below the roof element 13 so as to illuminate the collection plate 2, even in the absence or scarcity of sunlight.

Optionally, in the case wherein the side walls 10 and the roof element 13 close the space above the collection plate 2, the system can also include one ventilation assembly (not shown in the drawings), to prevent the temperature at the collection plate 2 to increase too much, especially in the summer. The roof element 13 can be displaced with respect to the side walls 10, for example it can be hinged to one of them, so that the collection plate 2 can be easily reached, also from above, to carry out any cleaning and/or maintenance operations.

The system 1 according to the invention can optionally include also optionally oscillating or sliding entrance and exit doors, configured to allow for an easy entrance of one animal P in the box and at the same time, prevent the infiltration of rain water and/or snow therein.

The person skilled in the art will have no difficulty in understanding how the system 1 described above, provided with side walls 10 and roof element 13, can be used in an outdoor environment, for example in a park or even on a terrace or balcony.

The system 1 of the invention can also include one pheromones diffuser assembly, configured to deliver continuously or at predetermined intervals an essence based on pheromones, so that animals are attracted by the system 1 of the invention and will approach thereto without fear.

In view of the above it is quite evident that the system for collection and disposal of animal droppings, as described above, overcomes the drawbacks described in the introduction. In fact, by quickly collecting and disposing off droppings released by the animals on the collection plate 2, i.e. as soon as the animals leave the same plate, and by sanitizing the collection plate after each use and at regular intervals the spread of bacteria, viruses and dad odours in the surrounding environment is avoided and the environment is kept clean.

It is to be noted, moreover, that the configuration of the collection plate 2, including a bottom 22 and a support base 23, raised with respect to the bottom 22 and including an anti slip portion 231, prevents the animal P from stepping on its droppings. The animal P, in this way, will not get its feet dirty and, therefore, will not be able to dirty therewith the floor or ground of the surrounding environment—for example of the apartment—wherein the system 1 can be installed, and prevents also the animal, due to its dirty feet, from accidentally slipping thereby hurting itself.

Not only that, the fact that the support base 23 is placed parallel to the floor or ground, at a reduced distance, or even coplanar, as described above, allows for the elder animals P, with mobility problems, of big size (that cannot be easily lifted by their owners) to easily reach the support base 23 and to carry out in total safety their physiological functions.

No less important, the system 1 of the invention is also very handy for the owners of these animals that no longer need to manually remove droppings from litter or sand.

The three automatic disposing systems described above—to be installed inside dwellings, within the public structures concerned, as well as in public spaces—allow for disposal of animal faecal matter without manual intervention and in conditions of absolute hygiene. Being able to use suitable disposal systems and appropriate spaces where carrying out their physiological needs, domestic animals will not longer dirty sidewalks, squares, parks etc., thereby safeguarding the health of the environment and safeguarding human beings from potential diseases.

The disposal systems with automatic discharge of droppings also safeguard animal health, in favour of which the European Union recommends measures for their protection and for their well-being. (See the paragraph concerning Animal welfare in the “Treaty of Lisbon”, signed in 2007 by all the EU Member States).

The system for the collection and disposal of animal droppings described above may be, finally, easily implemented in environments that are among the most varied, a non-exhaustive list of which is provided:
Private homes
Cabins/Boxes to be placed in parks, on sidewalks, etc.
Hospital structures (with the Decree of the President of the Council of Ministers of 28 Feb. 2003 the use of pets for assisted activities and treatments is recognized as an official therapy: Pet Therapy)
Hospitals that accept domestic animals in corridors during visiting hours
Pet Hotels
Dog Friendly Museums (archaeological museums, castles, botanical gardens, archaeological sites, outdoors art galleries, mining museums, civic picture galleries, etc.)
Swimming Pools
Beaches in areas reserved for people with pets
Kennels
Kicking areas (fenced green areas, public areas, exclusively for pets)
Prisons wherein pet therapy is practised for recovery of emotional relationships (www.canidentro.it; paws4prisons)
Public Offices, where employees can bring their pets (their presence contributes to dampen conflicts and create a more relaxed atmosphere)
Dog Units of law enforcements, as for example the Finance Police.

In the foregoing the embodiments were described and some modifications of the present invention have been suggested, but it should be understood that those skilled in the art can make modifications and changes without departing from the relative scope of protection, as defined by the appended claims.

Thus, for example, the data control and processing unit 8 as well as the sensor group 7, the assembly 5 for opening-closing the reservoir 6 and the adjustment group 9 can be powered by alkaline batteries, optionally of the type AA 1.5 V and their autonomy can be shown by lighting leds, close to exhaustion of the same.

The system 1 according to the invention can also include two or more collection plates 2, juxtaposed to each other but separated by one wall or side wall, optionally 40 cm or more high, whereby it is possible to obtain one “set” of collection plates, that can be used for example in places where the turnout of animals P is high and could create queues for the use of the system 1. In this case, the reservoir 3 should be consistently connected to each collection plate.

1. Automatic system for collection and disposal of animal droppings, including:
at least one collection plate, configured to receive animal droppings released by one animal supported by said at least one collection plate, at least one discharge through opening being formed in said collection plate;
one reservoir for a washing fluid, in fluid communication with said at least one collection plate;
one assembly for opening-closing said reservoir;
at least one sensor group, configured to sense the presence or absence of at least one animal at said at least one collection plate;
one data control and processing unit operatively connected to said sensor group and to the assembly for opening-closing said reservoir;
whereby when the data control and processing unit senses, by means of the sensor group, that an animal previously supported by said at least one collection plate is moving away therefrom, the data control and processing unit sends a control signal to the opening closing assembly, in response to which the reservoir is opened and the washing fluid is dispensed in said at least one collection plate dragging therewith, in the discharge through opening, any droppings located on said at least one collection plate;
wherein
said at least one collection plate includes:
a bottom wherein the discharge through opening is formed, wherein said bottom has a configuration in plan view which is circular or polygonal, more optionally square or rectangular,
and a support base for supporting said animal, which said support base is raised with respect to said bottom and includes at least one anti-slip portion.

2. System according to claim 1, wherein said support base is central or peripheral with respect to the bottom of said at least one collection plate.

3. System according to claim 1, wherein said support base is planar.

4. System according to claim 1, wherein said support base is configured to be placed parallel to the floor or the ground of the environment wherein the system is installed.

5. System according to claim 1, wherein the sensor group includes one or more between a weight sensor, a position sensor or presence sensor.

6. System according to claim 1, including two side walls opposite with respect to said at least one collection plate and delimiting at least one entrance and at least one exit with respect to said at least one collection plate, the entrance and exit being optionally mutually opposite to each other with respect to said at least one collection plate.

7. System according to claim 6, comprising including at least one roof element for said at least one collection plate, supported by said side walls, when present.

8. System according to claim 1, wherein the reservoir and the discharge through opening are connected to a water mains and to a sewer, respectively, or wherein the reservoir is stand-alone and the discharge through opening is in fluid communication with the reservoir for collecting wastewater.

9. System according to claim 1, wherein the data control and processing unit is connected to an electric network or is battery-powered.

10. System according to claim 1, including one adjustment group which is operatively connected to the assembly for opening-closing the reservoir and to the data control and processing unit, which adjustment group is configured to adjust the flow rate and pressure of the washing fluid delivered by the reservoir, based on what sensed by the sensor group and processed by the data control and processing unit.
